(19) United States
(12) Patent Application Publication
(10) Pub. No.: US 2005/0204395 A1
(43) Pub. Date: Sep. 15, 2005

(54) Computer system for storage of remote video signals and the method thereof

(76) Inventors: Tung-Peng Wu, Taipei (TW); Chi-Min Liu, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/073,659

(22) Filed: Mar. 8, 2005

(30) Foreign Application Priority Data
Mar. 9, 2004 (TW) 093106243

(51) Int. Cl. H04N 7/173; H04N 7/18; H04N 7/16

(52) U.S. Cl. 725/89; 725/88; 725/87; 725/102; 725/142

(57) ABSTRACT

A computer system for storage of remote video signals and the method thereof is disclosed. A first operating system and a second operating system with lower consumption of system resources are installed in a computer system. Users operate the computer system to receive remote video signals and save them in a storage unit under the second operating system. At the same time, an index table is established to record the storage location of the remote video signals. The method for receiving remote video signals firstly is to input an external command into a central processing unit of the computer system through an input unit of the computer system. After receiving the external command, the central processing unit drives a video signal receiving unit of the computer system to receive remote video signals and save them inside a storage unit of the computer system. An index table is established to record locations of the remote video signals.

### BACKGROUND OF THE INVENTION

The present invention relates to a computer system for storage of remote video signals and the method thereof, especially to a computer system and method that receives and records storage locations of the remote video signals simultaneously. Thus the display fluency of video signals is improved while displaying the stored video signals after being fast-forwarded and the recording time of video signals is reduced.

By the raising of living standards and the economic slowdown, modern people lives under high competitive environment. There it is an important issue to relieve physical and emotional hardship. Most of people relax from the pressure by watching TV (television) programs, movies and listening to music. Due to fast developing of technology, the computer system with multi-functions in connection with other devices, especially multimedia system for entertainment, becomes an essential equipment of modern people. Thus there is no need to buy electronic products for displaying compact disk (CD), digital versatile disc (DVD), Video Compact Disc (VCD) television programs or broadcasting so as to avoid the occupation of interior space.

For making living, people need to work until quite late so that they can't watch the favorites TV programs on time and are forced to give up the daily leisure. Thus most of the computer systems available now has the function of recording programs in advance. However, when the recorded data are displaying, after using the fast-forward buttons and then displaying again causes a delay. Moreover, it takes longer time to burn the recorded TV programs or films onto a storage medium. The details are described in the followings.

Most of the data received and stored in computer systems are compressed and encoded such as MPEG (Motion Pictures Expert Group) data—an encoded data stream which contains compressed audio and video information. Refer to FIG. 1, a schematic drawing of group of pictures (GOP) of MPEG is disclosed. The group of pictures of MPEG has three types of coded frames—an I (Intra) frame 60, a P (Predicted) frame 70, and a B (Bi-directional) frame 80. The I frame 60 is used as a reference frame. The group of pictures starts by encoding a complete representation of the first frame, this is known as an Intra-Frame (or I-Frame) 60.

Similar to a JPEG image, the redundant and repeated information is dealt with by mathematical techniques such as Discrete Cosine Transform (DCT), Quantization and Huffman Encoding.

Generally, most frames are similar to the ones preceding as well as succeeding them. P frame 70 depends on the preceding frame—I frame 60, only differences between the frames can be encoded. That is, for areas of the images which have not changed between the two frames, they are skipped while for areas that have changed slightly compared to the reference frame, they are encoded and saved. B frame 80 depends on both the preceding as well as the succeeding frame. There are two other frames necessary to reconstruct the B frame 80. In practice, the sizes of the I-frames 60 are biggest while the B-frames 80 have the smallest sizes. There is no certain sequence of these three types of frames.

P frame 70 and B frame 80 are predicted from the preceding and the succeeding frames. It is impossible to reconstruct them without the data of other frame. I (Intra) Frame 60 coding techniques restrict themselves to compressing information contained within a particular frame. It can be reconstructed without any reference to other frames. Thus I frame 60 is the first frame of the group of pictures. P frame 70 and B frame 80 need to take into account information of I frame. Thus I frame 60 needs special protection so as to avoid loss or damage of images.

Therefore, when display MPEG data, the I frame 60 must be found first because a group of pictures starts with an I frame and ends with frame right before next I frame. When users stop in fast forward mode, the frame may be fallen on P frame 70 or B frame 80, the display software looks for previous I frame 60 for displaying the frames of the video. This introduces a delay after fast forwarding of the video data. Furthermore, when burning the MPEG data onto an optical storage medium, the computer system needs to search the locations of each I frame 60 and then starts burning process. Thus users need to wait for a period of time-lead time for burning.

Moreover, due to the requirements for prevention of computer virus infection, system management and system stability, loadings and resources consumption of Windows operating system keep increasing. Even only a single application program is used, users still need to wait for a longer time to turn on the computer system. This causes waste of time and low efficiency.

### SUMMARY OF THE INVENTION

It is therefore a primary object of the present invention to provide a computer system for storage of remote video signals and the method thereof by which the computer system receives remote video signals and saves them into a storage unit under an operating system with low resource consumption. An index table for recording locations of the remote video signals is established while saving the signals so that when users display the stored video signals after using the fast-forward buttons, there is no delay. Also the resource consumption of the computer system during process of receiving signals is reduced. Therefore, the efficiency of the computer system is raised.

It is therefore another object of the present invention to provide a computer system for storage of remote video signals and the method thereof that after the remote video signals are saved for a period of time, or in certain amount, the computer system opens another file and keeps saving signals into the new storage file until all the remote video signals are saved. This is for the convenience of managing the burning and storage of the remote video signals.

The present invention uses a computer system with a first operating system and a second operating system to receive remote video signals under the second operating system with lower resource consumption. When users want to save the remote video signals, firstly they need to input an external command into a central processing unit of the computer system by an input unit. After receiving the external command, the central processing unit sends a driving signal to a video signal receiving unit of the computer system for receiving the remote video signals. Finally, the remote video signals are saved inside a storage unit of the computer system and an index table is established simultaneously for recording locations of the video signals. Moreover, while receiving and saving the remote video signals, the computer system opens a storage file in the storage unit for saving signals. After a period of time or certain amount of data being saved, another new storage file is opened and the remote video signals are saved into the new storage file until all the signals are saved.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a schematic drawing of the MPEG frames;

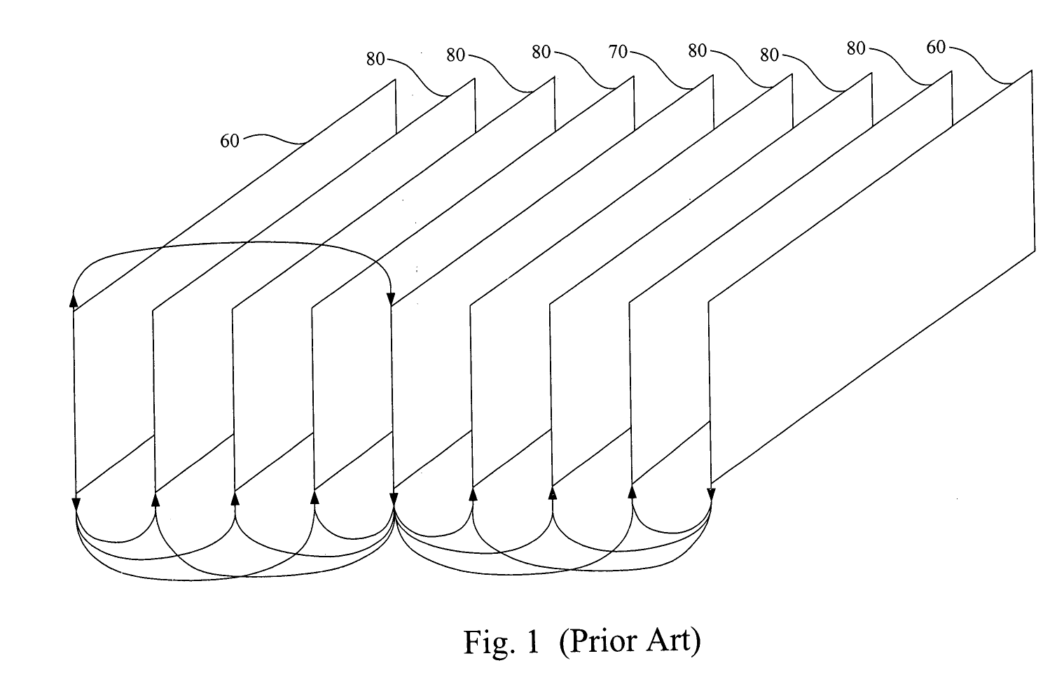

FIG. 2 is a block diagram of an embodiment in accordance with the present invention;

FIG. 3 is a flow chart of an embodiment in accordance with the present invention;

FIG. 4 is a block diagram of another embodiment in accordance with the present invention;

FIG. 5 is a flow chart of another embodiment in accordance with the present invention.

### DETAILED DESCRIPTION OF THE PREFFERED EMBODIMENT

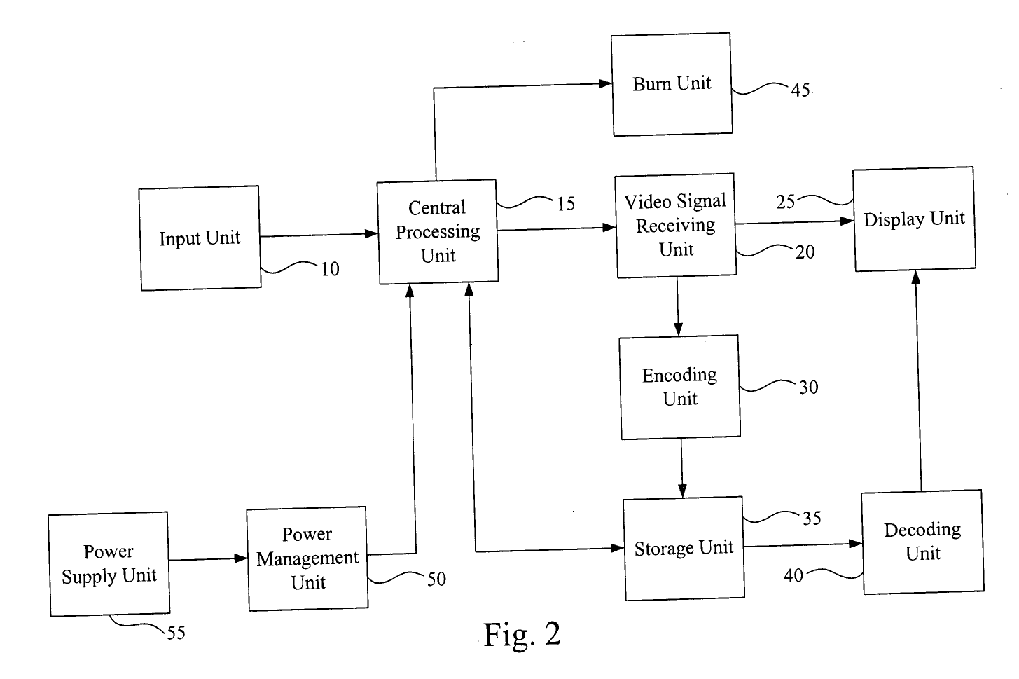

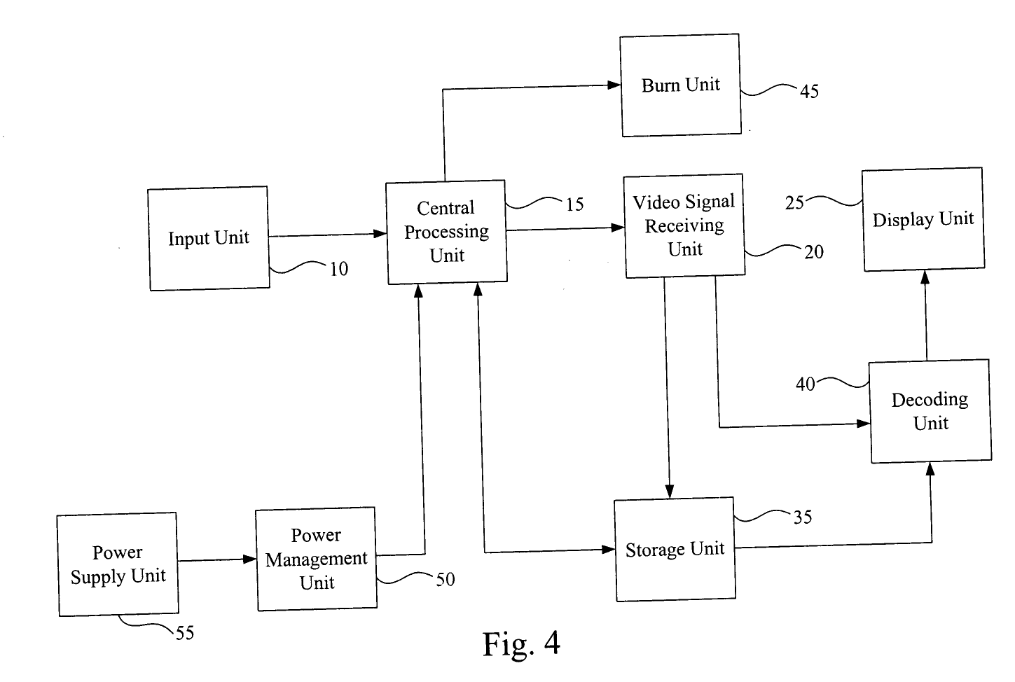

Refer to FIG. 2, a computer system in accordance with the present invention consists of an input unit 10 for inputting an external command into a central processing unit 15 by users that want to receive remote video signals. Users can set up the start time they intend to receive remote video signals, the channel of remote video signals, and the end time for receiving remote video signals. The input unit 10 can be a keyboard or a remote controller. And a video signal receiving unit 20 is used for receiving remote video signals. When the received remote video signals are analog signals, the video signal receiving unit 20 converts them into digital video signals. While receiving unencoded/uncompressed video data, the video signal receiving unit 20 directly transmits the video data into a display unit 25 for displaying. But when the received remote video signals are encoded/compressed, as shown in FIG. 4, the video signals are sent to a decoding unit 40 for being decoded and then transmitted to the display unit 25 for displaying.

When receiving unencoded/uncompressed video signals, the video signal receiving unit 20 transmits the video signals to an encoding unit 30 for processing into compressed data and then sent to a storage unit 35 for storage. The storage unit 35 is a hard disk (HD). The decoding unit 40 receives the encoded compressed data in the storage unit 35, decodes and transmits the data into the display unit 25. A burn unit 45 reads data stored in the storage unit 35 through the central processing unit 15 and burns data onto optical disk data storage materials for the convenience of carriage. A power management unit 50 is coupled with the central processing unit 15 that works according to the preset time for receiving remote video signals. When it is start time, the power management unit 50 supplies power to the central processing unit 15 until the end time. Then the power management unit 50 stops providing electricity so as to save power. Furthermore, the power management unit 50 is connected with a power supply unit 55 to get the power source.

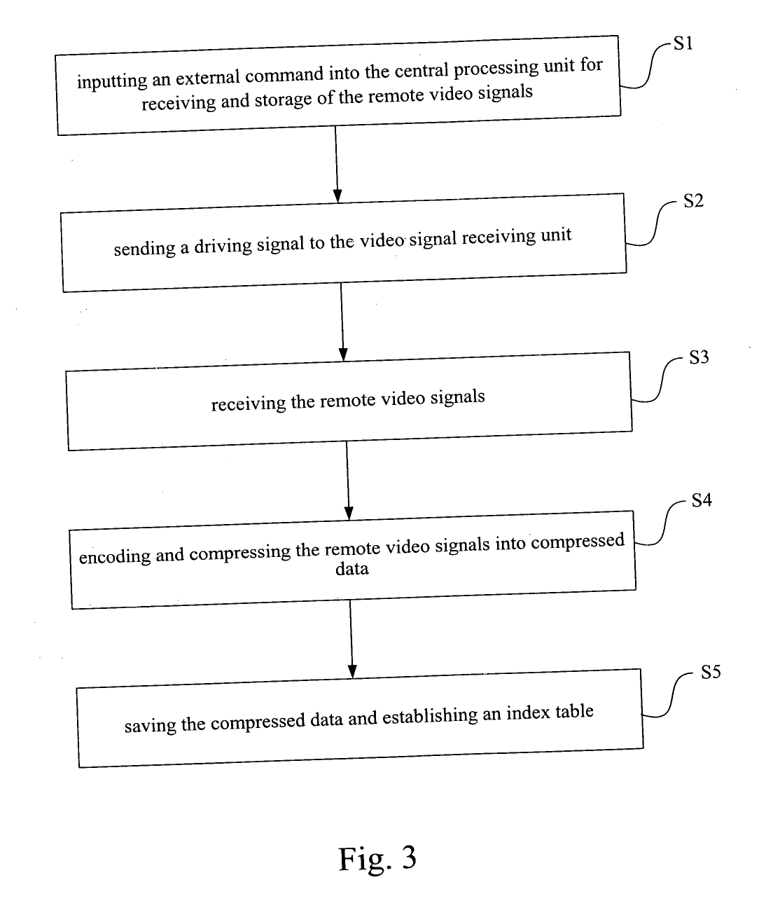

Refer to FIG. 3, a flow chart of an embodiment in accordance with the present invention is disclosed. A computer system in accordance with the present invention is installed with a first operating system and a second operating system. The first operating system having higher system resource consumption is a Windows operating system such as Windows XP, Windows NT, Window 98, Windows 2000 and Windows Me, with at least one application program installed therein. The second operating system is an operating system with lower system resource consumption such as Linux operating system. The second operating system shares the application programs of the first operating system with the first operating system. The method in accordance with the present invention is run under the second operating system.

Refer to step S1, at first users need to input an external command into the central processing unit 15 through the input unit 10 for receiving and storage of the remote video signals. Then as shown in step S2, after receiving the external command, the central processing unit 15 sends a driving signal to the video signal receiving unit 20. Refer to step S3, once the video signal receiving unit 20 receives the remote video signals, if the video signals are analog video signals, they are converted into digital video signals by the video signal receiving unit 20. Then the remote video signals are transmitted to the encoding unit 30 for being encoded and compressed into compressed data in MPEG format as shown in step S4. At last, refer to step S5, the compressed data is saved in the storage unit 35 and at the same time an index table is established. The index table records locations of full frame of the compressed data such as I frame in MPEG data.

Furthermore, while saving the compressed data, a storage file is opened on a storage unit 35 by the computer system. After saving data for a period of time, or saving certain amount of data, the computer system opens another file and keeps saving data into the new storage file until all the remote video signals are saved. The duration and size of the storage files can be set depending on users needs. The data saved in storage files with certain durations or sizes by the method of the present invention is convenient for users to be burned on optical disks for the convenience of carriage.

After receiving all the remote video signals, if users want to display the stored compressed video signals, the decoding unit 40 decodes the compressed data in the storage unit 35 and then transmitted them into the display unit 25 for viewing images. Due to the index table for recording locations of each I frame in MPEG data, established at the time the remote video signals are saved in the storage unit 35, there is no image delay when the video signals are decoded for display after being fast forwarded. Thus the display fluency of video signals is improved. Moreover, when users operate the computer system to burn the compressed data inside the storage unit 35 onto an optical disk by the burn unit 45, the index table and the compressed data of remote video signals are recorded directly, without the need to search locations of each I frame so that the recoding time is reduced.

In addition, users can input external command into the central processing unit 15 through the input unit 10 to preset the start time for receiving remote video signals, the channel of remote video signals, and the end time for receiving remote video signals. When it's near start time, the power management unit 50 supplies power to the central processing unit 15 for initiating the second operating system with lower resource consumption as well as driving the video signal receiving unit 20 to receive remote video signals in preset channel. Then as the above flow chart, the step S4 and the step S5 are run in sequence. However, when the end time is up, the power management unit 50 stops power supply to the central processing unit 15 for electricity saving.

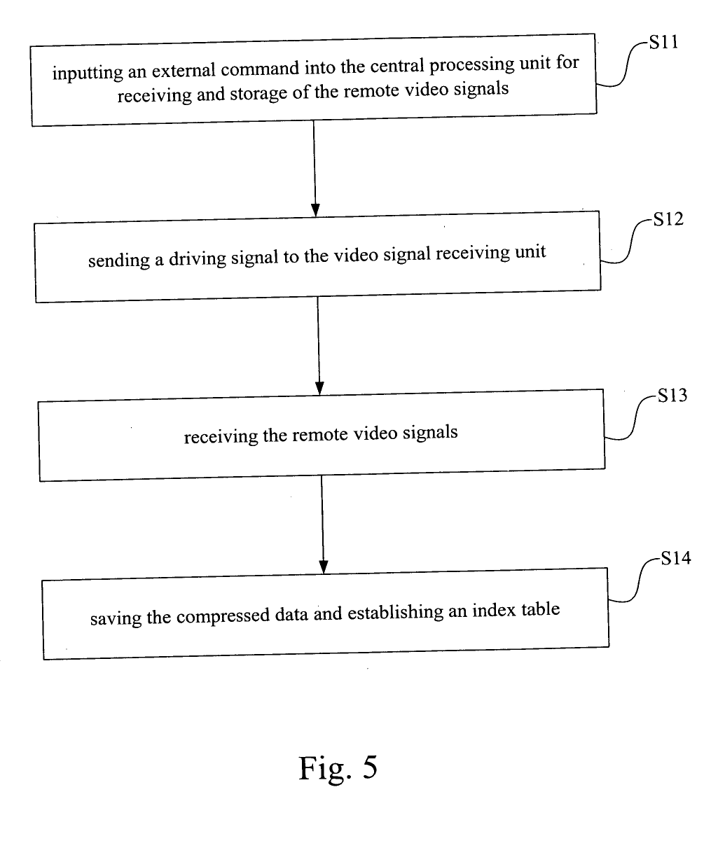

Refer to FIG. 4 & FIG. 5, a block diagram and flow chart of another embodiment according to the present invention are disclosed. The difference between this embodiment and above embodiment is in that the remote video signals received by the video signal receiving unit 20 are already MPEG data. Thus there is no need to process the data by the encoding unit 30. This embodiment doesn't have the encoding unit 30. And the received remote video signals must be processed by the decoding unit 40 for being decoded so as to be transmitted to the display unit 25 for viewing images.

In summary, a computer system for storage of remote video signals and the method thereof in accordance with the present invention receives and stores remote video signals under the second operating system with lower resource consumption so that the resource consumption of the computer system is reduced. And while saving the video data, an index table recording locations of the stored remote video signals is also established at the same time. Thus the there is no image delay when the video signals are decoded for display by the computer system after being fast-forwarded. Thus the quality of display images is improved. Moreover, while recording video data onto a storage medium, there is not need to search locations of each compressed full frame so that the recording time is reduced. Furthermore, the present invention saves remote video signals in storage files with certain durations or sizes such as 650 MB/74 min [symbol] 700 MB/80 min optical disks available on the market now. This is convenient for users to burn, store and mange the data.

Additional advantages and modifications will readily occur to those skilled in the art. Therefore, the invention in its broader aspects is not limited to the specific details, and representative devices shown and described herein. Accordingly, various modifications may be made without departing from the spirit or scope of the general inventive concept as defined by the appended claims and their equivalents.

1. A computer system for storage of remote video signals installed with a first operating system and a second operating system with lower resource consumption, which receives remote video signals under the second operating system comprising:
a video signal receiving unit for receiving remote video signals;
a storage unit for saving the remote video signals received by the receiving unit;
an index table recording the locations of the remote video signals in the storage unit;
an input unit for inputting an external command by users; and
a central processing unit for receiving the external command from the input unit and driving the video signal receiving unit to receive the remote video signals.

2. The computer system for storage of remote video signals as claimed in claim 1, wherein the input unit is a remote controller.

3. The computer system for storage of remote video signals as claimed in claim 1, wherein the input unit is a keyboard.

4. The computer system for storage of remote video signals as claimed in claim 1, wherein the video signal receiving unit converts remote analog video signals into digital video signals.

5. The computer system for storage of remote video signals as claimed in claim 1, wherein the index table records locations of full frames of remote video signals.

6. The computer system for storage of remote video signals as claimed in claim 1, wherein the computer system further having an encoding unit for receiving, encoding and compressing the remote video signals transmitted from the video signal receiving unit into compressed data and then transmitting the compressed data into the storage unit.

7. The computer system for storage of remote video signals as claimed in claim 6, wherein the remote video signals are encoded and compressed into MPEG (Motion Pictures Expert Group) format.

8. The computer system for storage of remote video signals as claimed in claim 7, wherein locations of each I frame of the remote video signals in MPEG format are recorded in the index table.

9. The computer system for storage of remote video signals as claimed in claim 6, wherein the computer system further having a decoding unit for retrieving and decoding the compressed data in the storage unit.

10. The computer system for storage of remote video signals as claimed in claim 9, wherein the computer system further having a display unit for receiving and displaying the compressed data being decoded by the decoding unit.

11. The computer system for storage of remote video signals as claimed in claim 1, wherein the computer system further having a decoding unit for decoding the decoded and—compressed remote video signals that received by the video signal receiving unit.

12. The computer system for storage of remote video signals as claimed in claim 11, wherein the computer system further having a display unit for receiving and displaying data being decoded by the decoding unit.

13. The computer system for storage of remote video signals as claimed in claim 1, wherein the computer system further having a burn unit for retrieving and burning the index table as well as the remote video signals inside the storage unit onto a storage medium.

14. The computer system for storage of remote video signals as claimed in claim 1, wherein through the input unit, users input the external command into the central processing unit to preset start time for receiving the remote video signals, a channel of the remote video signals, and end time for receiving the remote video signals; when it is the start time, the central processing unit drives the video signal receiving unit to receive the remote video signals and save them into the storage unit.

15. The computer system for storage of remote video signals as claimed in claim 14, wherein the computer system further having a power management unit connected with the central processing unit; after presetting conditions for receiving the remote video signals by the central processing unit, the power management unit provides no power to the central processing unit until near start time for receiving the remote video signals; after receiving and saving all the remote video signals, the power supply from the power management unit to the central processing unit is off again.

16. The computer system for storage of remote video signals as claimed in claim 15, wherein the power management unit is further connected with a power supply unit.

17. The computer system for storage of remote video signals as claimed in claim 1, wherein the remote video signals are video signals of television programs.

18. The computer system for storage of remote video signals as claimed in claim 1, wherein the first operating system is a Windows operating system.

19. The computer system for storage of remote video signals as claimed in claim 1, wherein the second operating system is a Linux operating system.

20. The computer system for storage of remote video signals as claimed in claim 1, wherein the second operating system shares at least one application program installed in the first-operating system with the first operating system.

21. A method for storage of remote video signals applied to a computer system that receives remote video signals under the second operating system and having a first operating system as well as a second operating system with lower resource consumption comprising the steps of:
inputting an external command for receiving remote video signals into a central processing unit of the computer system;
after receiving the external command, the central processing unit sending a driving signal to a video signal receiving unit of the computer system;
receiving the remote video signals by the video signal receiving unit; and
saving the remote video signals into a storage unit of the computer system and establishing an index table at the same time.

22. The method for storage of remote video signals as claimed in claim 21, wherein the index table records locations of full frames of remote video signals.

23. The method for storage of remote video signals as claimed in claim 21, wherein the remote video signals being received during the step of receiving the remote video signals are data in MPEG format and the locations of each I frame of the data in MPEG format are recorded in the index table.

24. The method for storage of remote video signals as claimed in claim 21, wherein the step of receiving the remote video signals that are analog signals further comprising the steps of:
converting the remote video signals into digital video signals; and
encoding and compressing the digital video signals into compressed data and then transmitting the compressed data into the storage unit.

25. The method for storage of remote video signals as claimed in claim 21, wherein the step of receiving the remote video signals that are digital video signals further comprising the step of: encoding and compressing the digital video signals into compressed data and transmitted the compressed data into the storage unit.

26. The method for storage of remote video signals as claimed in claim 24, wherein the remote video signals are encoded and compressed into data in MPEG format.

27. The method for storage of remote video signals as claimed in claim 25, wherein the remote video signals are encoded and compressed into data in MPEG format.

28. The method for storage of remote video signals as claimed in claim 26, wherein locations of each I frame of the data in MPEG format are recorded in the index table.

29. The method for storage of remote video signals as claimed in claim 27, wherein locations of each I frame of the data in MPEG format are recorded in the index table.

30. The method for storage of remote video signals as claimed in claim 21, wherein on step of saving the remote video signals into a storage unit, the computer system opens a storage file for saving the remote video signals; after a period of time, the computer system opens another new storage file and keeps saving data into the new storage file until all the remote video signals are saved; the time period of the storage file is set up by users.

31. The method for storage of remote video signals as claimed in claim 21, wherein on step of saving the remote video signals into a storage unit, the computer system opens a storage file for saving the remote video signals; after certain amount of data being saved, the computer system opens another new storage file and keeps saving data into the new storage file until all the remote video signals are saved; the size of the storage file is set up by users.

32. The method for storage of remote video; signals as claimed in claim 21, wherein users input the external command into the central processing unit for presetting start time for receiving the remote video signals, a channel of the remote video signals, and end time for receiving the remote video signals; when it is the start time, the central processing unit drives the video signal receiving unit to receive the remote video signals and save them into the storage unit.

33. The method for storage of remote video signals as claimed in claim 32, wherein after presetting conditions for receiving the remote video signals, there is no power supply for the central processing unit until near the start time for receiving the remote video signals; after receiving and saving all the remote video signals, the power supply is off again.

34. The method for storage of remote video signals as claimed in claim 21, wherein the remote video signals are video signals of television programs.

35. The method for storage of remote video signals as claimed in claim 21, wherein the first operating system is a Windows operating system.

36. The method for storage of remote video signals as claimed in claim 21, wherein the second operating system is a Linux operating system.

37. The method for storage of remote video signals as claimed in claim 21, wherein the second operating system shares at least one application program installed in the first operating system with the first operating system.
